(19) United States
(12) Patent Application Publication
(10) Pub. No.: US 2012/0324251 A1
(43) Pub. Date: Dec. 20, 2012

(54) OPTIMIZED HIBERNATE MODE FOR WIRELESS DEVICE

(75) Inventors: Wladyslaw Bolanowski, Lund (SE); Hans Wieser, Lund (SE)

(73) Assignee: SONY MOBILE COMMUNICATIONS AB, Lund (SE)

(21) Appl. No.: 13/504,137

(22) PCT Filed: May 26, 2011
(86) PCT No.: PCT/IB11/01138

§ 371 Date: Apr. 26, 2012

(51) Int. Cl. G06F 1/26

(52) U.S. Cl. 713/300

(57) ABSTRACT

A system and method for reducing in boot time in an electronic device. In one embodiment, a command to power off the electronic device is received. An amount of information stored in at least one of the plurality of memory banks of RAM containing data is calculated. A determination is made as to whether the RAM has sufficient storage space to store compacted data and also form a RAM disk in a portion of the RAM, wherein the step of determining is based at least in part on the amount of information calculated. A RAM disk is initiated in an available memory bank of RAM. The RAM is compacted and a hibernate command is executed wherein the RAM disk is a target for storing the compacted RAM. Power is maintained to memory banks that form the RAM disk and the processor of the portable communication device is set to a power collapse mode.

This application is a national phase of International Application No. PCT/IB2011/001138 filed May 26, 2011 and published in the English language.

### TECHNICAL FIELD OF THE INVENTION

The technology of the present disclosure relates generally to a system and method for improving boot time in an electronic device.

### BACKGROUND

It generally takes a substantial amount of time for many electronic devices to be ready for use upon being turned on by a user. This is especially true for electronic devices that require time for booting up prior to normal operation. It would be convenient to reduce booting time for such electronic devices.

There are already conventional methods available to support reduced boot time. For example, boot time could be reduced by avoiding a cold boot each time the devices is powered down. Another method is a so called “hibernate mode”, which generally means that random access memory (RAM) content is stored in a non-volatile memory prior to the electronic device entering a power off state. At the electronic device power on state, the stored RAM content is read back from the NVM and RAM content is restored to the same status as just before entering the power off state. One problem with the hibernate mode is that it takes considerable time to store the RAM contents and also considerable time to restore the RAM from the NVM. Another problem is that all stored information is not safe when stored in the NVM.

Another method is a so called “standby mode”. In the standby mode, generally, after the electronic device has entered the power off state, the entire RAM is kept in the refresh mode. At the restart of the phone, all RAM is ready to run including both applications and their RAM data. One problem with this method is the power consumption to keep the whole RAM in the refreshed mode.

### SUMMARY

The present disclosure overcomes the above problems by defining a system and method that re-uses the logic for hibernate mode with improved performance by using a RAM disk or other storage device instead of a NVM disk combining it with the standby mode with improved power consumption. As disclosed herein, the system state is assumed to be preserved in RAM in a power efficient manner by using only the minimum RAM part (as few memory banks as possible), which are refreshed. The remaining memory banks of the RAM will be powered down.

One aspect of the invention relates to a method to store data to reduce boot time in a portable communication device, the method includes: receiving a command to power off the portable communication device, wherein the portable communication device includes a random access memory (RAM) comprising a plurality of memory banks; calculating an amount of information stored in at least one of the plurality of memory banks containing data; determining whether the RAM has sufficient storage space to have at least one un-used memory bank after the data is compacted in the RAM, wherein the step of determining is based at least in part on the amount of information calculated; compacting the RAM, wherein the at least one of the memory banks containing data is stored in one or more memory banks in consecutive locations without unused RAM between the stored data to form a compacted RAM; maintaining power to the memory banks that form the compacted RAM; set the at one least un-used memory bank to a power off mode; and set an application processor coupled to the RAM to a power collapse mode.

Another aspect of the invention relates to after receiving the command to power off the portable communication device, the portable communication device is placed in an active airplane mode.

Another aspect of the invention relates to prior to calculating the amount of information stored, applications initiated by the user are terminated.

Another aspect of the invention relates to additionally including terminating sub-systems associated with the portable communication device prior to calculating an amount of information stored.

Another aspect of the invention relates the sub-systems to be terminated include at least one selected from the group consisting of: switching off a display, un-mount an external memory card, and set any peripheral device coupled to the portable communication device to a standby mode or off mode.

Another aspect of the invention relates to the compacted RAM being indexed using an original address table stored in the RAM.

Another aspect of the invention relates to the compacted RAM being indexed using a MMU that includes re-addressed addresses that corresponds to addresses of the data in the compacted RAM.

Another aspect of the invention relates to the compacted RAM are maintained in a self refresh mode.

One aspect of the invention relates to a method to reduce boot time in a portable communication, the method including: receiving a command to power off the portable communication device, wherein the portable communication device includes a random access memory (RAM) comprising a plurality of memory banks; calculating an amount of information stored in at least one of the plurality of memory banks containing data; determining whether the RAM has sufficient storage space to store compacted data and also form a RAM disk in a portion of the RAM, wherein the step of determining is based at least in part on the amount of information calculated; initiate the RAM disk in an available memory bank of RAM; compacting the data stored in the RAM, wherein the data is stored in the RAM in consecutive locations without unused RAM between the stored data to form a compacted RAM; execute a hibernate command, wherein the RAM disk is a target for storing the compacted RAM; maintaining power to memory banks that form the RAM Disk; and set application processor of the portable communication device to a power collapse mode.

Another aspect of the invention relates to after receiving the command to power off the portable communication device, the portable communication device is placed in an active airplane mode.

Another aspect of the invention relates to prior to calculating an amount of information stored, applications initiated by the user are terminated.

Another aspect of the invention relates to terminating sub-systems associated with the portable communication device prior to calculating an amount of information stored.

Another aspect of the invention relates to the sub-systems being terminated includes at least one selected from the group consisting of: switching off a display, un-mount an external memory card, and set any peripheral device coupled to the portable communication device to a standby mode or off mode.

Another aspect of the invention relates to the compacted RAM being indexed using an original address table stored in the RAM.

Another aspect of the invention relates to the compacted RAM being indexed using a MMU that includes re-addressed addresses that corresponds to addresses of the data in the compacted RAM.

Another aspect of the invention relates to the RAM disk being maintained in a self refresh mode.

One aspect of the invention relates to a method to reduce boot time in a portable communication, the method comprising: receiving a command to power off the portable communication device, wherein the portable communication device includes a random access memory (RAM) comprising a plurality of memory banks; compacting the RAM, wherein the at least one of the memory banks containing data is stored in consecutive locations without unused RAM between the stored data to form a compacted RAM; transfer the compacted RAM to a phase change memory; set all memory banks of the portable communication device to a power off mode; and set an application processor coupled to the memory banks of the portable communication device to a power collapse mode.

Another aspect of the invention relates to after receiving the command to power off the portable communication device, any modem powered by the portable communication device is set to a power off mode.

Another aspect of the invention relates to terminating sub-systems associated with the portable communication device prior to calculating an amount of information stored.

Another aspect of the invention relates to the sub-systems to be terminated includes at least one selected from the group consisting of: switching off a display, un-mount an external memory card, and set any peripheral device coupled to the portable communication device to a standby mode or off mode.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

FIG. 1 is an exemplary embodiment of an electronic device in accordance with aspects of the present invention.

FIG. 2 is a schematic block diagram of the exemplary electronic device of FIG. 1.

FIG. 3 is an exemplary RAM having a plurality of memory banks in accordance with aspects of the present invention.

FIGS. 4-7 are an exemplary method in accordance with aspects of the present invention.

FIGS. 8-11 are another exemplary method in accordance with aspects of the present invention.

FIGS. 12-15 are another exemplary method in accordance with aspects of the present invention.

### DETAILED DESCRIPTION OF EMBODIMENTS

Embodiments will now be described with reference to the drawings, wherein like reference numerals are used to refer to like elements throughout. It will be understood that the figures are not necessarily to scale.

Described below in conjunction with the appended figures are various embodiments of an improved system and method for launching one or more computer application programs. Although the invention will be described in connection with a mobile telephone, it will be appreciated that aspects of the disclosed method may be applied to other electronic devices such as, but not limited to, cameras, music players, personal digital assistants, desktop computers, laptop computers, tablet computers, netbook computers, etc.

The present invention provides a system and method for improving boot time associated with an electronic device with improved power performance. As described herein the state of the electronic device is assumed to be preserved in RAM in a power efficient manner by using only the minimum RAM part (as few memory banks as possible), which are refreshed. The remaining memory banks of the RAM will be powered down. In another embodiment, a phase change memory is utilized to store the RAM contents and upon transfer of the RAM contents to the phase change memory, all of the memory banks of the RAM are powered down.

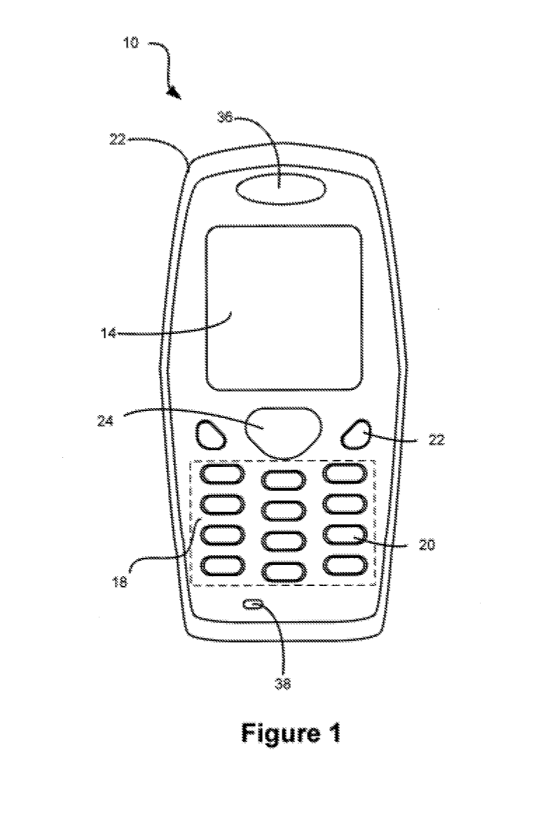

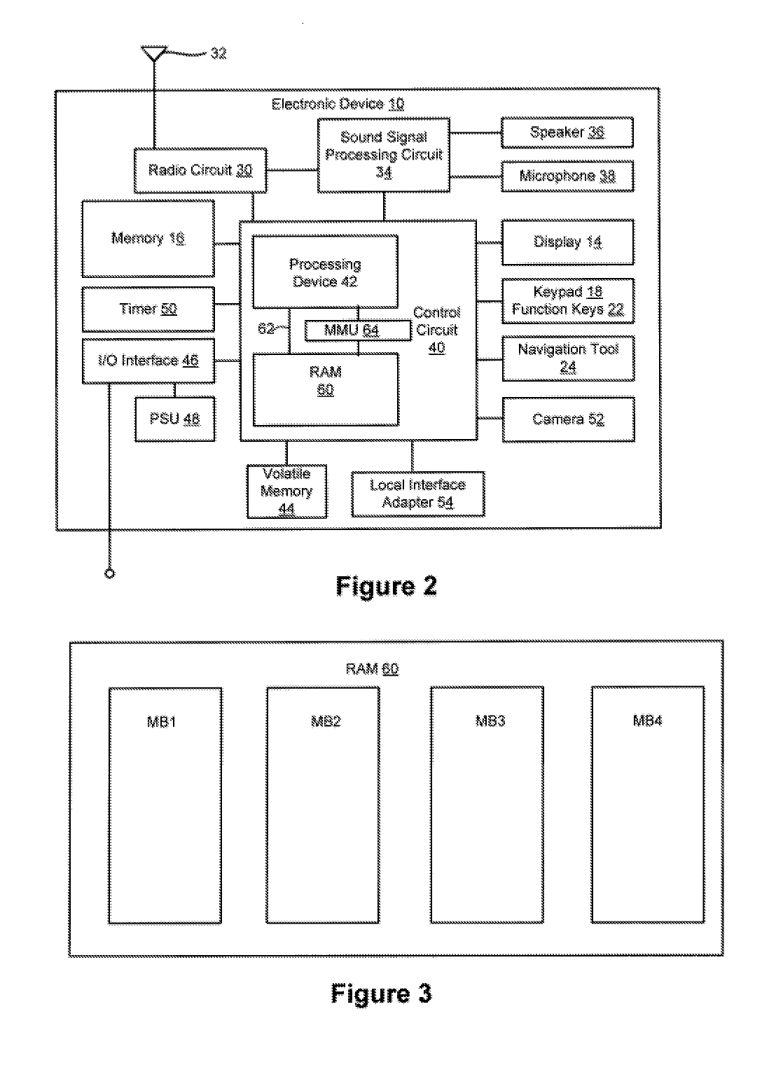

Referring initially to FIGS. 1 and 2, an electronic device 10 in the form of a mobile telephone is illustrated. The mobile telephone 10 is shown as having a “brick” or “block” design type housing 12, but it will be appreciated that other type housings, such as a clamshell housing or a slide-type housing, may be utilized without departing from the scope of the invention. The mobile telephone 10 includes a display 14. The display 14 displays information to a user such as operating state, time, telephone numbers, contact information, various navigational menus, etc., which enables the user to utilize the various feature of the mobile telephone 10. The display 14 may also be used to visually display content or information accessible by the mobile telephone 10 from an internal memory 16 or one or more remote sources (e.g., a media server, a network, etc.).

The mobile telephone 10 further includes a keypad 18 that provides for a variety of user input operations. For example, the keypad 18 may include alphanumeric keys 20 for allowing entry of alphanumeric information such as telephone numbers, phone lists, contact information, notes, etc. In addition, the keypad 18 typically may include special function keys 22 such as a “call send” key for initiating or answering a call, and a “call end” key for ending, or “hanging up” a call. A navigation tool 24 may also be included to allow the user to easily toggle and or move a cursor on the display and/or for assisting a user to navigate through a menu displayed on the display 14 to select different telephone functions, profiles, settings, etc., as is conventional. Other keys associated with the mobile telephone 10 may include a volume key, audio mute key, an on/off power key, a web browser launch key, a camera key, etc. Keys or key-like functionality may also be embodied as a touch screen associated with the display 14. One or more the above input devices (e.g., keypad 18, function keys 22, navigation tool 24) may be used by a user to select an application to execute on the mobile telephone 10.

The mobile telephone 10 includes conventional call circuitry (e.g., radio circuit 30) that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

Continuing to refer to FIGS. 1 and 2, the mobile telephone 10 includes an antenna 32 coupled to a radio circuit 30. The radio circuit 30 includes a radio frequency transmitter and receiver for transmitting and receiving signals via the antenna 32 as is conventional. The mobile telephone 10 generally utilizes the radio circuit 30 and antenna 32 for voice, Internet and/or E-mail communications over a cellular telephone network. The mobile telephone 10 further includes a sound signal processing circuit 34 for processing the audio signal transmitted by/received from the radio circuit 30. Coupled to the sound processing circuit 34 are the speaker 36 and a microphone 38 that enable a user to listen and speak via the mobile telephone 10, as is conventional. The radio circuit 30 and sound processing circuit 34 are each coupled to the control circuit 40 so as to carry out overall control of the functions and operations of the mobile telephone 10.

The control circuit 40 may include a processing device 42, such as a CPU, microcontroller or microprocessor. The processing device 42 executes code stored in a memory (not shown) within the control circuit 48 and/or in a separate memory, such as memory 16, and/or other non-volatile or volatile memory 44, in order to carry out conventional operation of the mobile telephone 20. The memory 44 may be, for example, a buffer, a flash memory, a hard drive, a removable media, and/or any type of device that is capable of storing contents when power has been removed from the device. In addition, the memory 44 may be, for example, a buffer, RAM or any other source of volatile electronic storage. In addition, the processing device 42 executes code to carry out various functions of the mobile telephone 10.

The mobile telephone 10 also includes the aforementioned display 14, keypad 18, function keys 22 and navigation tool 24 coupled to the control circuit 40. The mobile telephone 10 further includes an I/O interface 46. The I/O interface 46 may be in the form of typical mobile telephone I/O interfaces, such as a multi-element connector at the base of the mobile telephone 10. As is typical, the I/O interface 46 may be used to couple the mobile telephone 10 to a battery charger to charge a power supply unit (PSU) 48 within the mobile telephone 10. In addition, or in the alternative, the I/O interface 46 may serve to connect the mobile telephone 10 to a wired personal hands-free adaptor, to an external electronic device (e.g., personal computer or other device) via a data cable, etc. For example, the I/O interface 46 may be a universal port that may be coupled to a cable to connect the mobile telephone 10 to a personal computer. The universal port may be a universal serial bus (USB) port, which receives a USB cable for connection to a USB port of a personal computer.

The mobile telephone 10 may also include a timer 50 for carrying out timing functions. Such functions may include timing the durations of calls, generating the content of time and date stamps, etc.

The mobile telephone 10 may include various built-in accessories, such as a camera 52 for taking digital pictures and/or videos. Image files corresponding to the pictures and videos may be stored in the memory 44. In one embodiment, the mobile telephone 10 also may include a position data receiver (not shown), such as a global positioning satellite (GPS) receiver, Galileo satellite system receiver or the like.

To establish wireless communication with other locally positioned devices, such as a headset, another mobile telephone, a computer, etc., the mobile telephone 10 may include a local wireless interface adapter 54, such as a Bluetooth adaptor, infrared adapter, near field communication adapter, etc. The wireless interface adapter 54 will generally enable the mobile telephone 10 to communicate with a variety of electronic devices.

Referring to FIGS. 2 and 3, the mobile telephone 10 includes random access memory (RAM) 60. The RAM 60 is operably coupled to the control circuit 40 through a memory bus 62. The RAM 60 includes a plurality of memory banks. As illustrated in FIG. 3, the RAM 60 includes four memory banks. A person of ordinary skill in the art will readily appreciate that the illustrated RAM 60 may contain any number of memory banks and memory banks may be of any desired size. Four memory banks (MB1-MB4) are shown to illustrate aspects of the present invention.

RAM 60 is directly or indirectly connected to the central processing unit 42 via the memory bus 62. The memory bus 62 generally comprises two buses: an address bus and a data bus. In order to access RAM 60, the processing device 42 generally sends a memory address, which indicates the desired location of data in the RAM, through the address bus. The processing device 42 reads or writes the data using the data bus.

Additionally, a memory management unit (MMU) 64 is a device coupled between CPU and RAM. The MMU 64 provides an abstraction of virtual memory. The MMU 64 reduces the problem of fragmentation of memory. After blocks of memory 60 have been allocated and freed, the free memory may become fragmented (discontinuous) so that the largest contiguous block of free memory may be much smaller than the total amount. With virtual memory, a contiguous range of virtual addresses can be mapped to several non-contiguous blocks of physical memory.

The following text discloses various methods to store data in an electronic device to reduce “boot time” in the electronic device. One skilled in the art will readily appreciate that the following methods are exemplary in nature and that the steps outlined may occur serially, in parallel and in any order.

As used herein the phrase “boot time” means the time necessary to load and initialize the operating system for an electronic device. The boot process can be considered complete when the electronic device is ready to interact with the user, or the operating system is capable of running system programs or application programs.

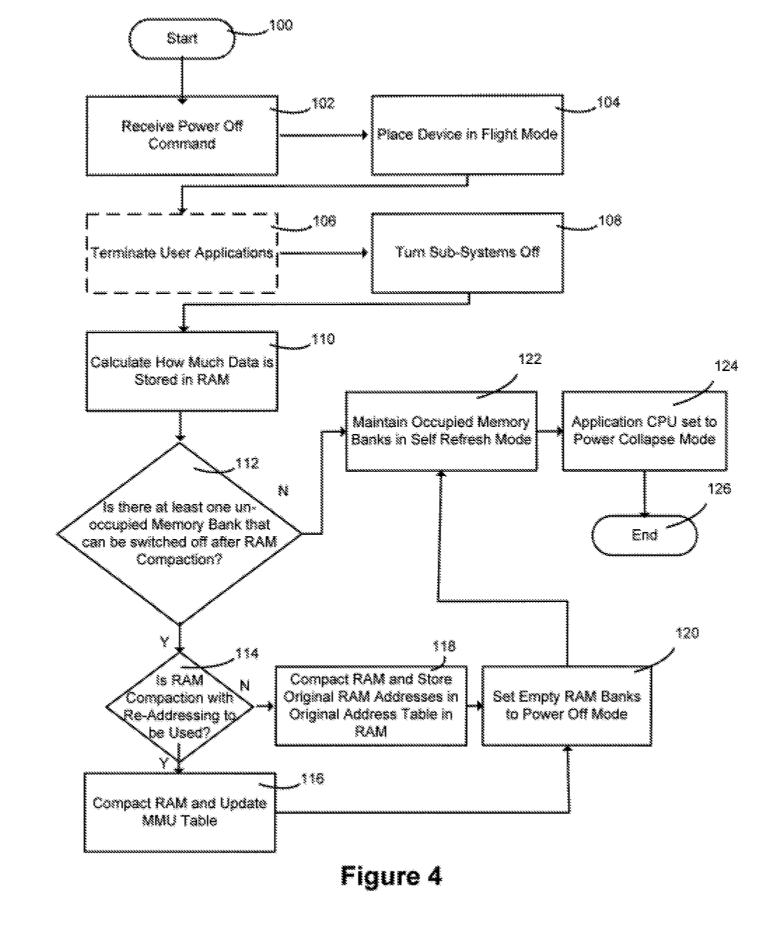

Referring to FIG. 4, an exemplary method 100 for reducing boot time in an electronic device (also referred to herein as a portable communication device) is illustrated. In the following examples, it will be assumed that the electronic device includes a plurality of memory banks of RAM.

At block 102, a command to power off the portable communication device is received by the processing unit. The command to power off the portable communication device 10 may be initiated by a user of the portable communication device and/or generated by one or more processes executed by the processing device 42.

At block 104, the portable communication device is placed in flight mode. As used herein, the phrase “flight mode” means that the device's signal transmitting functions are suspended or powered to an off state, which disables the device's capacity to place or receive calls or text messages while still permitting use of other functions that do not require signal transmission (e.g., games, built-in camera, MP3 player). Flight mode may allow operation of an FM receiver, Bluetooth, wireless LAN antenna and GPS, if the device is so equipped. However, preferably all un-necessary sub-systems will be switched off or terminated. One of ordinary skill in the art will readily appreciate that flight mode functionality may vary among manufacturers. Other common names for flight mode include airplane mode, offline mode, and standalone mode.

At block 106, an optional process step may include that all user applications are terminated. As used herein, the phrase “user applications” means software applications initiated by a user action or preference to perform singular or multiple related specific tasks. Examples include enterprise software, accounting software, office suites, graphics software and media players. User applications are contrasted with system software and middleware, which manage and integrate a computer's capabilities, but typically do not directly apply them in the performance of tasks that benefit the user, for example.

At block 108, sub-systems of the portable communication device 10 are placed in an off state. Sub-systems may include un-mounting memory devices (e.g., un-mounting an SD card), turning off the display 14, placing peripheral devices connected to the portable communication device 10 in standby mode or power off mode, etc.

At block 110, the processing unit 42 calculates an amount of information stored in the memory banks (e.g., MB1-MB4) containing data. This block is used to calculate how much data is stored in RAM 60.

At block 112, a determination is made as to whether there exists at least one un-occupied memory bank (e.g., MB1-MB4) that can be switched off after the RAM is compacted. As used, herein the term “compacted” means combining all of the allocated memory segments into a single block. The allocated memory segments are stored consecutively in the block without un-used RAM between the allocated memory segments. The block may run from one memory bank to another based on the size of the allocated memory segments.

If the determination made at block 112 is positive, process control moves to block 114. At block 114, a determination is made as to whether RAM compaction using re-addressing to be used. If the determination at block 114 is positive, process control moves to block 116. At block 116, the RAM is compacted and the MMU table is updated with the new addresses. If the determination at block 114 is negative, process control moves to block 118. At block 118, the RAM is compacted and the original RAM addresses are stored in the original address table in RAM.

After either block 116 or block 118 is executed, process control moves to block 120. At block 120, any memory banks that do not contain compacted data (e.g., empty memory banks) are set to a power “off” state. Since the empty memory banks do not contain needed information to assist in the boot process, power may be terminated to these banks to conserve power resources.

Process moves to block 122 after a negative determination at block 112 or completion of block 120. At block 122, the allocated memory segments (e.g., the memory banks containing compacted memory (from block 120) or all the memory banks if RAM compaction was not performed (from block 112) are maintained in a self-refresh mode. In the self-refresh mode, power is maintained to each of the memory banks containing data and the memory is refreshed periodically.

Process flow moves to block 124, wherein the application processing device (e.g., processing device 42) is set to a power collapse mode. In a power collapse mode, the application processing device (e.g., processing device 42) is powered down to conserve power resources. The power collapse mode may be referred to as, for example, a Standby mode, a Sleep mode, or a Suspend mode depending on the operating system used. When placed in the power collapse mode, aside from the RAM that is required to restore the device's state, the computer attempts to cut power to all unneeded components of the device. Process flow then moves to block 126 for termination of the method.

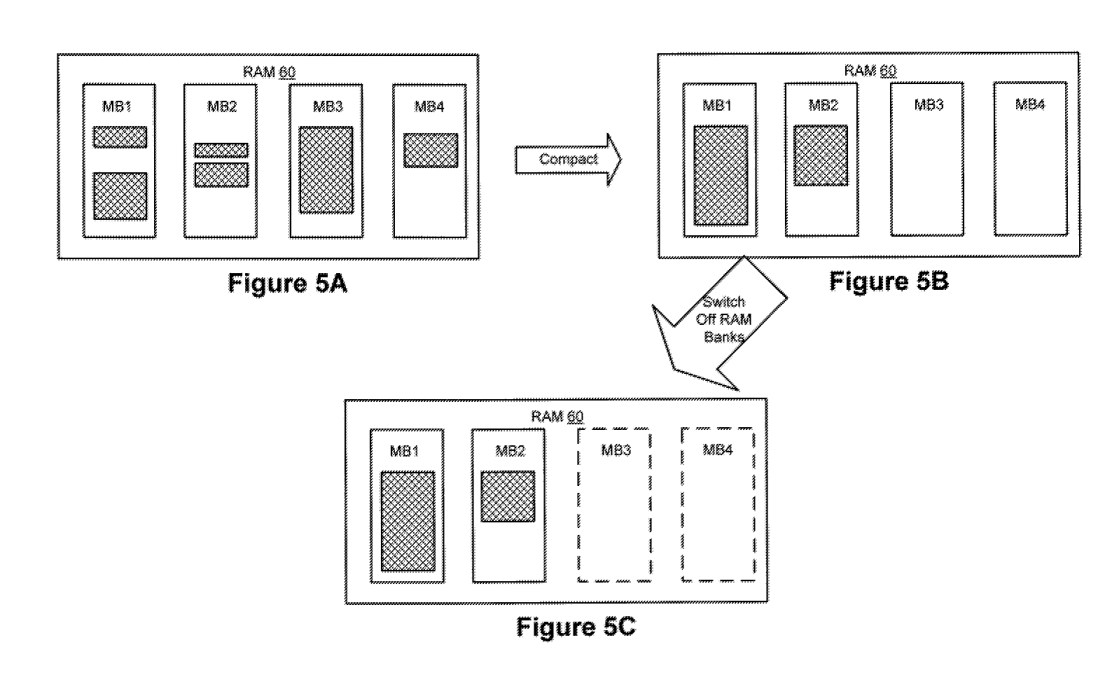

The method 100 is further illustrated in FIGS. 5A-5C. In FIG. 5A, RAM 16 is shown containing memory banks MB1-MB4, each of which contains allocated memory. A determination is made that after RAM compaction, at least one memory bank can turned to the off state. In FIG. 5B, the RAM is compacted in memory banks MB1 and MB2. FIG. 5B illustrates that the power to all of the memory banks MB1-MB4 is still on. After RAM compaction, memory banks MB3 and MB4 are turned off, as illustrated in FIG. 5C.

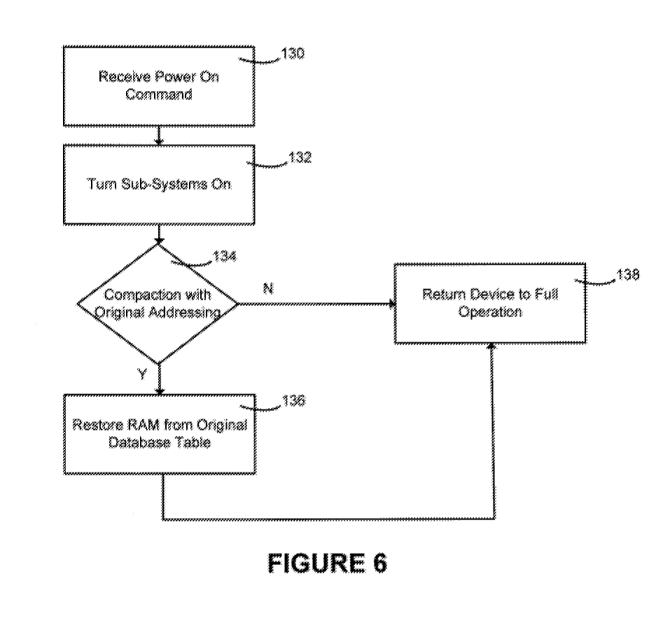

Upon receiving a power “on” command, process control moves to block 130 in FIG. 6. The power “on” command may be initiated by a user and/or initiated by a process or sub-process run by the portable communication device 10. Once the power “on” command is received process control moves to block 132. At block 132, the sub-systems of the portable communication device are turned “on”, including all memory banks that were previously turned “off”. At block 134, a determination is made as to whether the RAM was compacted with the original addressing or re-addressed. If RAM was compacted with original addressing, at block 136, the RAM is restored to its original RAM shape by moving the data stored in the compacted RAM in accordance with the original database table. Process flow moves to block 138. At block 138, the portable communication device is fully operational, which includes returning the portable communication from flight mode. If the decision at block 132 was negative (e.g., re-addressing was used), the MMU contains the updated address information. Flight mode may be terminated and the portable communication device is fully operational.

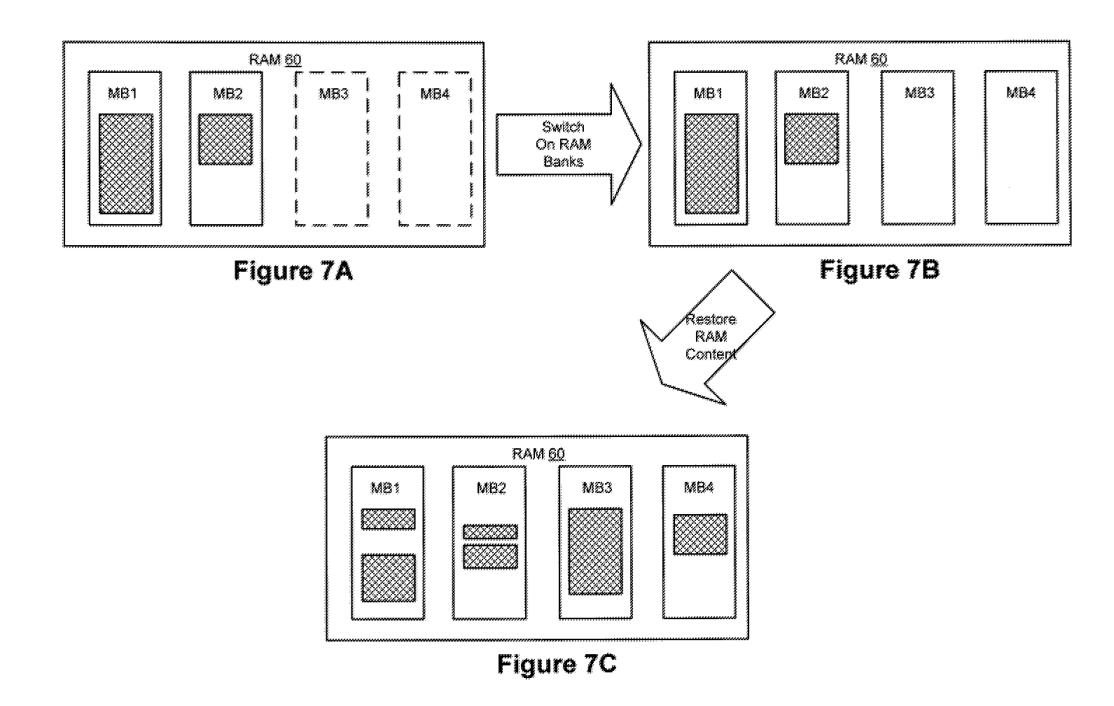

The process 130-138 is illustrated in FIGS. 7A-7C. In FIG. 7A, the RAM is shown with memory banks MB1 and MB2 containing compacted data. Memory banks MB3 and MB4 are in an “off” state. Memory banks MB3 and MB4 are turned to the “on” state, as illustrated in FIG. 7B. In FIG. 7C, the memory banks are restored to their original RAM shape.

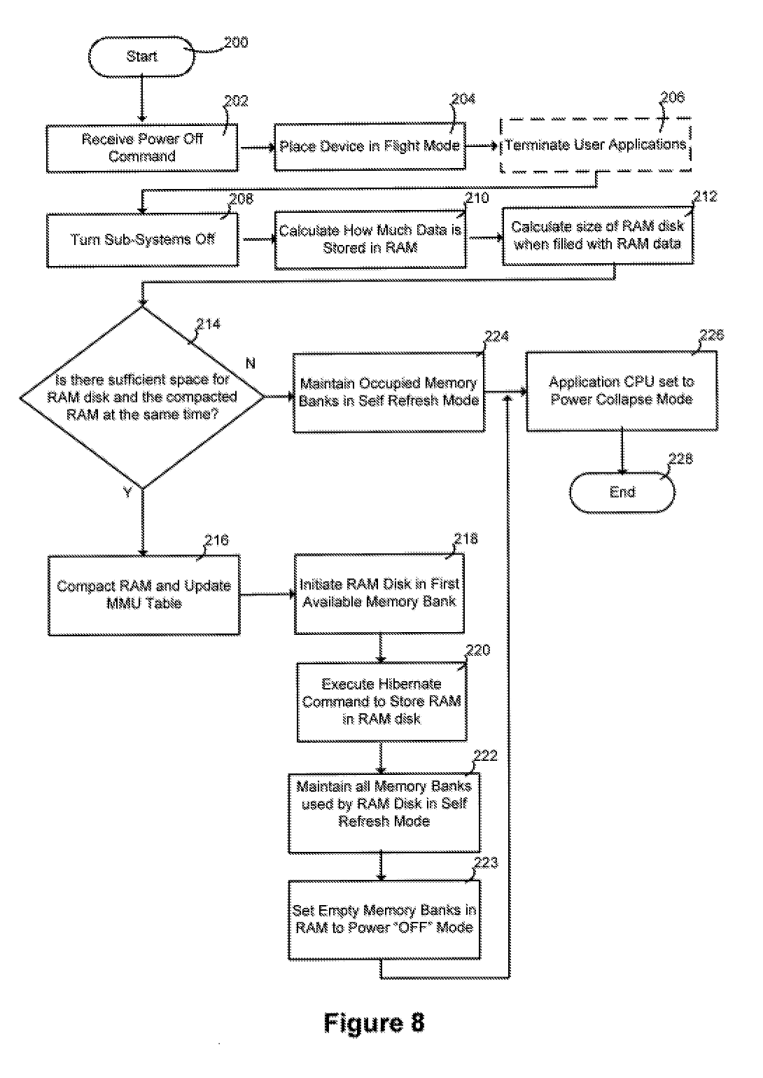

Referring to FIG. 8, exemplary method 200 for reducing boot time in an electronic device using a RAM disk is illustrated. Like the above example, it will be assumed that the electronic device includes a plurality of memory banks of RAM.

At block 202, a command to power off the portable communication device is received by the processing unit. The command to power off the portable communication device 10 may be initiated by a user of the portable communication device and/or generated by one or more processes executed by the processing device 42.

At block 204, the portable communication device is placed in flight mode.

At block 206, an optional process step may include that all user applications are terminated.

At block 208, sub-systems of the portable communication device 10 are placed in an “off” state. Sub-systems may include un-mounting memory devices (e.g., un-mounting an SD card), turning off the display 14, placing peripheral devices connected to the portable communication device 10 in standby mode or power off mode, etc.

At block 210, the processing unit 42 calculates an amount of information stored in the memory banks (e.g., MB1-MB4) containing data. This block is used to calculate how much data is stored in RAM 60.

At block 212, a calculation is made to determine the size of the RAM disk when filled with RAM data. A RAM disk or RAM drive is a block of RAM (primary storage or volatile memory) that may be treated as if the memory were a disk drive (secondary storage). A RAM disk is sometimes referred to as a “virtual RAM drive” or “software RAM drive” to distinguish it from a “hardware RAM drive” that uses separate hardware containing RAM, which is a type of solid-state drive. The performance of a RAM disk is in general orders of magnitude faster than other forms of storage media, such as an SSD, hard drive, tape drive or optical drive. This performance gain is due to multiple factors, including access time, maximum throughput and type of file system, as well as others.

At block 214, a determination is made as to whether there exists sufficient RAM storage for the RAM disk and the compacted RAM at the same time.

If the determination made at block 214 is positive, process control moves to block 216. At block 216, the RAM is compacted and the MMU table is updated.

Process control moves to block 218, where the RAM disk is created in an available memory bank.

Process control moves to block 220. At block 220 a Hibernate command is executed to store the compacted RAM in Ram disk and enter the portable communication device in a Hibernate mode.

Process control moves to block 222. At block 222, all memory banks used by the RAM disk are maintained in a self-refresh mode. Other memory banks (e.g., empty memory banks are placed in a power “off” to conserve power resources, as illustrated in block 223.

If the decision at block 214 was negative, process moves to block 224. At block 224, occupied memory banks are maintained in a self-refresh mode.

After either block 222 or block 224 is executed, process control moves to block 226. At block 226, the application processing device (e.g., processing device 42) is set to a power collapse mode, as discussed above. Process flow then moves to block 228 for termination of the method.

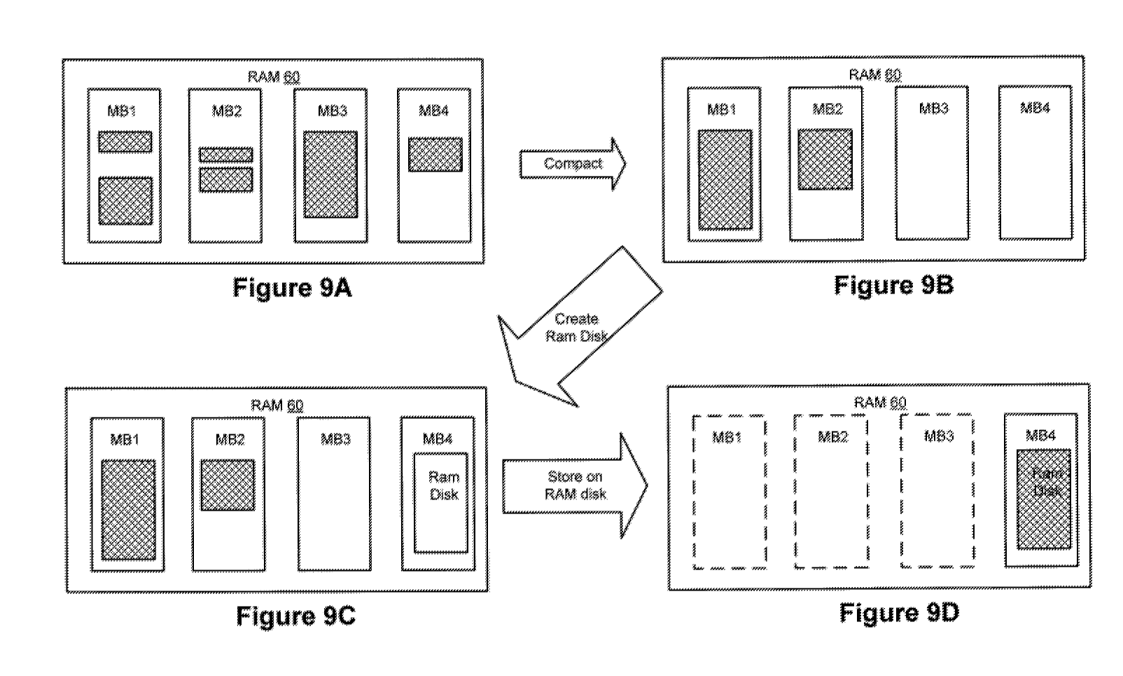

The method 200 is further illustrated in FIGS. 9A-9D. In FIG. 9A, RAM 60 is shown containing memory banks MB1-MB4, each of which contains allocated memory. A determination is made that there is sufficient RAM for creation of the RAM disk and storage of the compacted RAM at the same time. In FIG. 9B, the RAM is compacted in memory banks MB1 and MB2. FIG. 9C illustrates creation of the Ram disk. FIG. 9D illustrates that the compacted RAM is transferred to the RAM disk and all memory banks not associated with the RAM disk are power off.

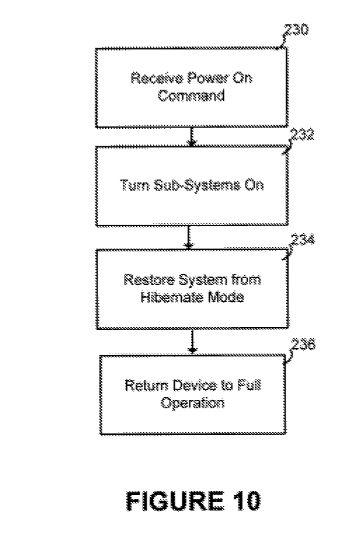

Upon receiving a power “on” command, process control moves to block 230 in FIG. 10. The power “on” command may be initiated by a user and/or initiated by a process or sub-process run by the portable communication device 10. Once the power “on” command is received process control moves to block 232. At block 232, the sub-systems of the portable communication device are turned “on”, including all memory banks that were previously turned “off”. At block 234, the system is restored from Hibernate mode. At block 236, the portable communication device is fully operational, which includes returning the portable communication from flight mode.

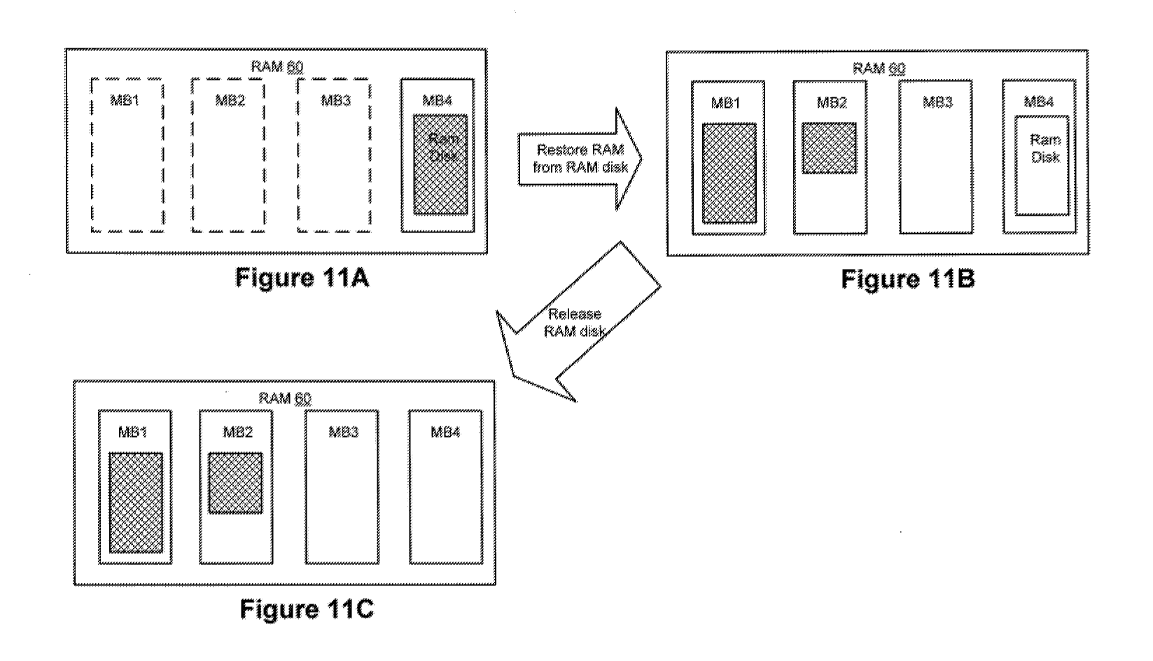

The process 230-236 is illustrated in FIGS. 11A-11C. In FIG. 11A, the RAM disk contains compacted memory from method 200 and all other memory banks turned off. In FIG. 11B, all memory banks are turned on and the compacted memory is restored from the RAM disk. In FIG. 11C, the RAM disk terminates (e.g., the memory bank containing the RAM disk is un-allocated).

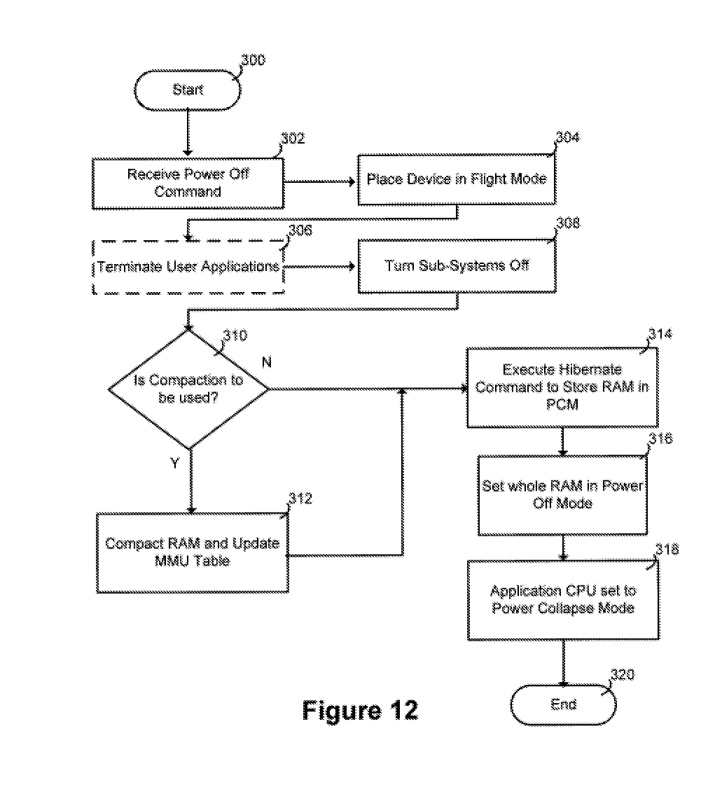

Referring to FIG. 12, another exemplary method 300 for reducing boot time in an electronic device using a RAM disk is illustrated. Like the above example, it will be assumed that the electronic device includes a plurality of memory banks of RAM.

At block 302, a command to power off the portable communication device is received by the processing unit. The command to power off the portable communication device 10 may be initiated by a user of the portable communication device and/or generated by one or more processes executed by the processing device 42.

At block 304, the portable communication device is placed in flight mode.

At block 306, an optional process step may include that all user applications are terminated.

At block 308, sub-systems of the portable communication device 10 are placed in an “off” state. Sub-systems may include un-mounting memory devices (e.g., un-mounting an SD card), turning off the display 14, placing peripheral devices connected to the portable communication device 10 in standby mode or power off mode, etc.

At block 310, if RAM compaction is to be used, process flow moves to block 312. At block 312, the RAM is compacted and the MMU table is updated. If RAM compaction is not to be used or upon the completion of block 312, process flow continues to block 314.

At block 314, a Hibernate command is executed to store the RAM contents (either compacted RAM (from block 312) or original RAM in a phase change memory (PCM), which is a type of non-volatile computer memory.

Process control moves to block 316. At block 316, all memory banks in the RAM 16 are turned to a power “off” state to reserve power resources. Process control moves to block 318. At block 318, the application processing device (e.g., processing device 42) is set to a power collapse mode, as discussed above. Process flow then moves to block 320 for termination of the method.

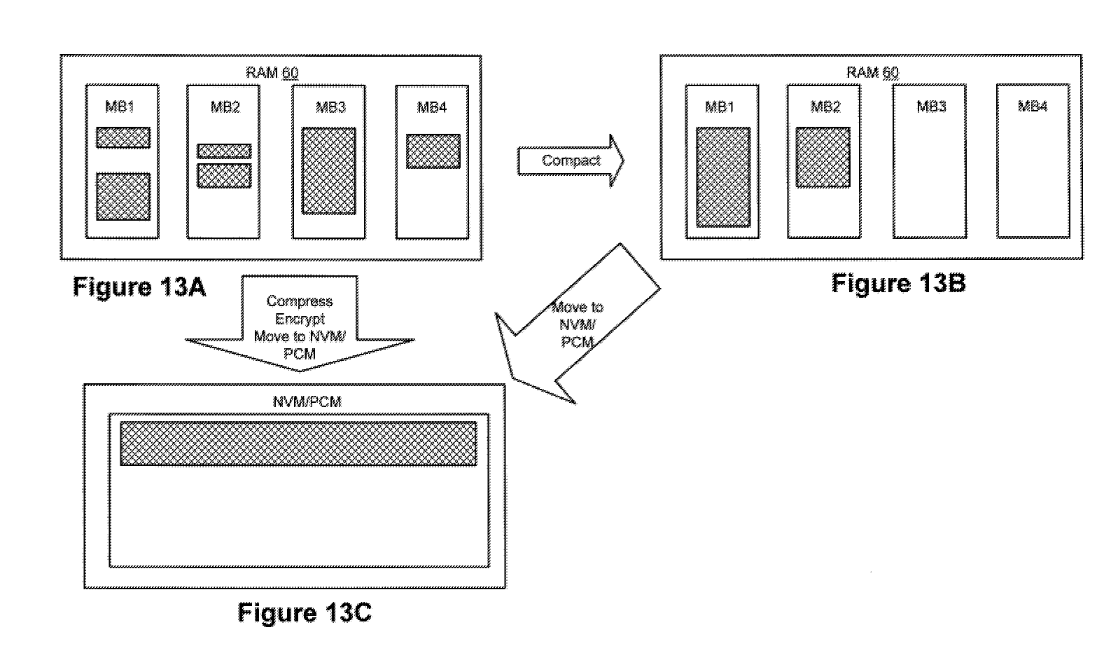

The method 300 is further illustrated in FIGS. 13A-13C. In FIG. 13A, RAM 16 is shown containing memory banks MB1-MB4, each of which contains allocated memory. A determination is made as to whether RAM compaction is be used prior to transfer of the RAM to PCM. FIG. 13B illustrates, the original RAM from FIG. 13A in a compacted form (e.g., compacted in memory banks MB1 and MB2. FIG. 13C illustrates the RAM contents being stored in the PCM. Once the RAM (in compacted or not compacted form) is moved to the PCM, the memory banks are placed in an “off” state.

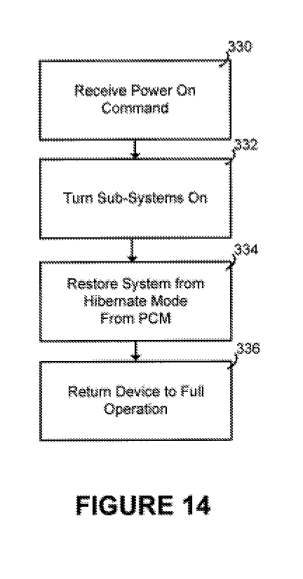

Upon receiving a power “on” command, process control moves to block 330 in FIG. 14. The power “on” command may be initiated by a user and/or initiated by a process or sub-process run by the portable communication device 10. Once the power “on” command is received process control moves to block 232. At block 332, the sub-systems of the portable communication device are turned “on”, including all memory banks that were previously turned “off”. At block 334, the system is restored from Hibernate mode from the PCM. At block 336, the portable communication device is fully operational, which includes returning the portable communication from flight mode.

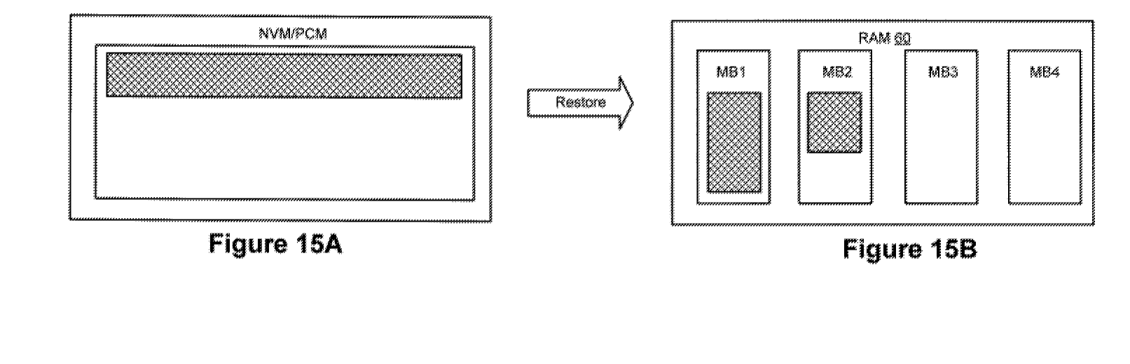

The process 330-336 is illustrated in FIGS. 15A-15B. In FIG. 15A, the PCM contains stored memory contents from method 300 and all other memory banks turned off. In FIG. 15B, all memory banks are turned on and the compacted memory is restored from the RAM disk and the device 10 is fully operational.

It will be apparent to a person having ordinary skill in the art of computer programming, and specifically in application programming for camera, mobile telephones and/or other electronic devices, how to program the electronic device 10 to operate and carry out logical functions associated with the methods for improving boot time described herein. Accordingly, details as to specific programming code have been left out for the sake of brevity. Also, while the functions and may be executed by respective processing devices in accordance with an embodiment, such functionality could also be carried out via dedicated hardware or firmware, or some combination of hardware, firmware and/or software.

Although certain embodiments have been shown and described, it is understood that equivalents and modifications falling within the scope of the appended claims will occur to others who are skilled in the art upon the reading and understanding of this specification.

1. A method to store data to reduce boot time in a portable communication device, the method comprising:
receiving a command to power off the portable communication device, wherein the portable communication device includes a random access memory (RAM) comprising a plurality of memory banks (MB1-MB4);
calculating an amount of information stored in at least one of the plurality of memory banks containing data;
determining whether the RAM has sufficient storage space to have at least one un-used memory bank after the data is compacted in the RAM, wherein the step of determining is based at least in part on the amount of information calculated;
compacting the RAM, wherein the at least one of the memory banks containing data is stored in one or more memory banks in consecutive locations without unused RAM between the stored data to form a compacted RAM;
maintaining power to the memory banks that form the compacted RAM;
set the at least one un-used memory bank to a power off mode; and
set an application processor coupled to the RAM to a power collapse mode.

2. The method of claim 1, wherein after receiving the command to power off the portable communication device, the portable communication device is placed in an active airplane mode.

3. The method of claim 1, wherein prior to calculating the amount of information stored, applications initiated by the user are terminated.

4. The method of claim 1, additionally including terminating sub-systems associated with the portable communication device prior to calculating an amount of information stored.

5. The method of claim 1, wherein the sub-systems to be terminated include at least one selected from the group consisting of: switching off a display, un-mount an external memory card, and set any peripheral device coupled to the portable communication device to a standby mode or off mode.

6. The method of claim 1, wherein the compacted RAM is indexed using an original address table stored in the RAM.

7. The method of claim 1, wherein the compacted RAM is indexed using a MMU that includes re-addressed addresses that corresponds to addresses of the data in the compacted RAM.

8. The method of claim 1, wherein the compacted RAM are maintained in a self refresh mode.

9. A method to reduce boot time in a portable communication device, the method comprising:
receiving a command to power off the portable communication device, wherein the portable communication device includes a random access memory (RAM) comprising a plurality of memory banks (MB1-MB4);
calculating an amount of information stored in at least one of the plurality of memory banks containing data;
determining whether the RAM has sufficient storage space to store compacted data and also form a RAM disk in a portion of the RAM, wherein the step of determining is based at least in part on the amount of information calculated;
initiate the RAM disk in an available memory bank of RAM;
compacting the data stored in the RAM, wherein the data is stored in the RAM in consecutive locations without unused RAM between the stored data to form a compacted RAM;
execute a hibernate command, wherein the RAM disk is a target for storing the compacted RAM;
maintaining power to memory banks that form the RAM Disk; and
set application processor of the portable communication device to a power collapse mode.

10. The method of claim 9, wherein after receiving the command to power off the portable communication device, the portable communication device is placed in an active airplane mode.

11. The method of claim 9, wherein prior to calculating an amount of information stored, applications initiated by the user are terminated.

12. The method of claim 9, additionally including terminating sub-systems associated with the portable communication device prior to calculating an amount of information stored.

13. The method of claim 12, wherein the sub-systems to be terminated includes at least one selected from the group consisting of: switching off a display, un-mount an external memory card, and set any peripheral device coupled to the portable communication device to a standby mode or off mode.

14. The method of claim 9, wherein the compacted RAM is indexed using a MMU that includes re-addressed addresses that corresponds to addresses of the data in the compacted RAM.

15. The method of claim 14, wherein a memory bank containing the RAM disk is maintained in a self refresh mode.

16. A method to reduce boot time in a portable communication device, the method comprising:
receiving a command to power off the portable communication device, wherein the portable communication device includes a random access memory (RAM) comprising a plurality of memory banks (MB1-MB4);
compacting the RAM, wherein the at least one of the memory banks containing data is stored in consecutive locations without unused RAM between the stored data to form a compacted RAM;
transfer the compacted RAM to a phase change memory;
set all memory banks of the portable communication device to a power off mode; and
set an application processor coupled to the memory banks of the portable communication device to a power collapse mode.

17. The method of claim 16, wherein after receiving the command to power off the portable communication device, any modem powered by the portable communication device is set to a power off mode.

18. The method of claim 16, additionally including terminating sub-systems associated with the portable communication device prior to calculating an amount of information stored.

19. The method of claim 16, wherein the sub-systems to be terminated includes at least one selected from the group consisting of: switching off a display, un-mount an external memory card, and set any peripheral device coupled to the portable communication device to a standby mode or off mode.
